(19) United States
(12) Patent Application Publication
(10) Pub. No.: US 2009/0282206 A1
(43) Pub. Date: Nov. 12, 2009

(54) Method for Resolving Memory Leak Problems Resulting from Loitering Objects

(75) Inventors: Maayan Goldstein, Holon (IL); Elliot Karl Kolodner, Haifa (IL); Onn Menahem Shehory, Yehud (IL); Yaron Weinsberg, Jerusalem (IL)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/119,205

(22) Filed: May 12, 2008

(51) Int. Cl. G06F 12/02

(52) U.S. Cl. 711/166; 711/E12.002

(57) ABSTRACT

The exemplary embodiments provide a computer implemented method, apparatus, and computer usable program code for managing memory. A suspect loitering object is detected for a set of selected applications, forming a detected object. The detected object is paged to persistent storage, forming a paged object. The paged object is deallocated from system memory, forming a deallocated object.

### BACKGROUND OF THE INVENTION

1. Field of the Invention

The present invention relates generally to data processing systems. More specifically, the present invention relates to a method, system, and computer program product for managing memory.

2. Description of the Related Art

Currently garbage collectors automatically free memory previously allocated by applications. A garbage collector is a software routine that searches memory for areas of inactive data and instructions in order to reclaim that space for a general memory pool, which is sometimes referred to as a heap. Generally, garbage collectors discard unreachable objects from memory, leaving reachable objects intact. Unreachable memory is a block of memory allocated dynamically where the program that allocated the memory no longer has any reachable pointer that refers to it. Similarly, an unreachable object is a dynamically allocated object that has no reachable reference to it.

In dynamic memory allocation implementations that employ a garbage collector, objects are reclaimed after they become unreachable. The garbage collector is able to determine if an object is reachable; any object that is determined to no longer be reachable can be deallocated. Many programming languages, including many object oriented programming languages, use automatic garbage collection.

However, object reachability does not necessarily imply usability, as an object may be obsolete and still reachable. An object is obsolete if there will be no further uses of the object by the application. Such objects are usually referred to as loitering objects. Loitering objects are obsolete objects that are still reachable.

Loitering objects is a form of memory leak that could occur in a Java™ application. Java™ and all Java™-based trademarks are trademarks of Sun Microsystems, Inc. in the United States, other countries, or both. A memory leak is a particular kind of unintentional memory consumption by a computer program where the program fails to release memory when no longer needed. Such memory leaks may result in degradation of application performance, and may eventually cause the application to fail due to memory shortage. Predicting, tracing, and removing loitering objects is a difficult problem. In fact, there is no known algorithm for finding all loitering objects.

Currently, the only solutions to eliminating loitering objects are manual solutions, or are performed statically. Manual solutions are only partial in scope, and are applicable only to very small systems. Static solutions are also limited in scope and are not applicable at runtime, or for dynamically changing systems. Static solutions are also not applicable for integrated systems comprised of third-party black-box components. Some manual solutions were provided for flat objects; however, complex objects have not been adequately addressed. A flat object is an object that has no data members of non-primitive data types. In Java™, primitive values do not share state with other primitive values. A complex object is an object that has data members of non-primitive data types. Primitive types are data types provided by a programming language as basic building blocks. Primitive types are also known as built-in types or basic types.

Accordingly, there is a need for a method, a system, and computer useable program code for resolving memory leaks resulting from loitering objects.

### BRIEF SUMMARY OF THE INVENTION

The exemplary embodiments provide a computer implemented method, apparatus, and computer usable program code for managing memory. A suspect loitering object is detected for a set of selected applications, forming a detected object. The detected object is paged to persistent storage, forming a paged object. The paged object is deallocated from system memory, forming a deallocated object.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram illustrating a system in which exemplary embodiments may be implemented;

FIG. 4 is flowchart illustrating the operation of managing memory in accordance with an exemplary embodiment;

FIG. 5 is flowchart illustrating the operation of detecting suspect loitering objects in accordance with an exemplary embodiment;

FIG. 6 is a flowchart illustrating the operation of paging a suspected loitering object to persistent storage in accordance with an illustrative embodiment;

FIG. 7 is a flowchart illustrating the operation of garbage collecting in accordance with an exemplary embodiment; and

FIG. 8 is a flowchart illustrating the reloading of a suspect loitering object in accordance with an exemplary embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

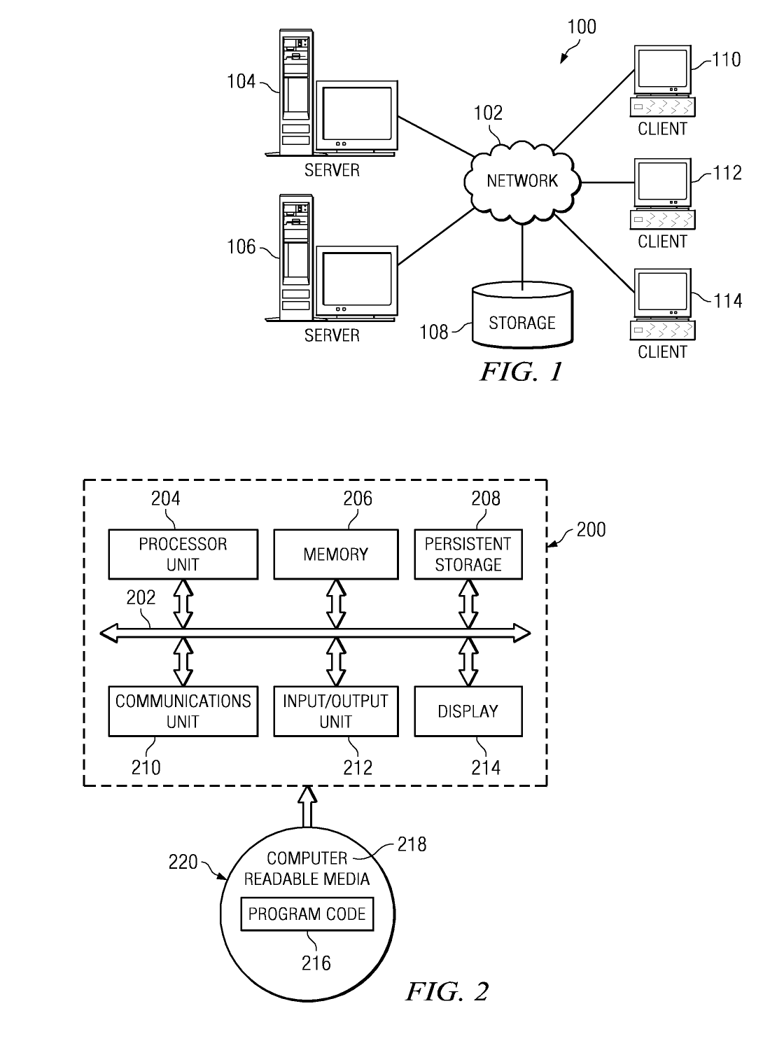

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media x18 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Exemplary embodiments provide for an automated, self-healing method for dealing with loitering objects. Self-healing means a system for monitoring for performance issues. The monitor analyzes the system to detect anomalies, determines the root cause of the anomalies, and fixes the problem. Fixing may take many forms, including, re-configuring the system, altering existing code, and so forth. In short, the system resolves the problem itself, with no intervention from outside source or human user.

Specifically, exemplary embodiments include a mechanism, an algorithm, and supporting data structures for solving the loitering objects problem. The mechanism may be implemented as a standalone solution or the mechanism may be integrated into other mechanisms. A prominent target for such integration would be the Java™ garbage collector.

Exemplary embodiments may be implemented in any object oriented programming language. The main idea of the algorithm is to locate live objects that are suspected as being loitering objects and “page” the suspected live objects to persistent storage. A live object is an object that has been constructed and initialized by an application along with the data members of the object, and the application has a reference to the object. The term “page” here (and throughout this document) refers to “logical paging.” Logical paging is a process by which an object is moved from the main memory to an external, persistent store, and possibly moved back to main memory again at a later time. This definition aims to distinguish between logical paging and physical paging. Whereas logical paging refers to moving objects to persistent storage, physical paging refers to moving whole pages to persistent storage. In particular, in computer operating systems that have their main memory divided into pages, physical paging, sometimes called swapping, is a transfer of pages between main memory and an auxiliary store, such as hard disk drive.

Paging the suspected live objects to persistent storage avoids the need to explicitly find out whether the suspected live objects are indeed loitering objects. In case these suspected live objects are needed by the application later on, the suspected live objects are re-loaded from persistent storage to memory, with all related synchronization issues being handled carefully, to avoid inconsistencies. Exemplary embodiments are designed to handle complex objects where each object may include a whole hierarchy of objects, and where objects may be referenced by multiple other objects.

Exemplary embodiments provide an automated run-time method for addressing the problem of loitering objects. Unlike previous solutions, which address memory problems on a system wide basis, exemplary embodiments manage memory leak problems on an application-by-application basis. That is, exemplary embodiments perform memory management when an application needs memory as opposed to when the entire system needs memory.

Exemplary embodiments detect suspect loitering objects by combining several criteria into a heuristic. A heuristic is the means of or relating to exploratory problem-solving techniques that utilize self-educating techniques, as in the evaluation of feedback, to improve performance. In an exemplary embodiment, the heuristic comprises at least one of the following three criteria: (1) the objects are part of collections, (2) the objects are annotated as suspected loitering objects, and (3) the objects are not accessed. That is, the last access time of the object is inspected. In various implementations, a user may wish to add other criteria specific to the user's problem or environment as part of the heuristic.

In another exemplary embodiment, suspect loitering objects are detected using a systematic algorithm. A systematic algorithm may be alternatively called “algorithm,” “analytic method,” “analysis method,” or “analytic algorithm.” A systematic algorithm examines all alternatives of relevance to a solution to analyze the problem at hand, whereas heuristics select a subset of the alternatives in and “educated” way.

The detected suspect loitering objects are paged to persistent storage. In an exemplary embodiment, any access to a suspect loitering object is performed via a proxy. A proxy is an intermediary unit managing interaction between other units, e.g., as a broker. Another exemplary embodiment may implement the same functionality within its healing unit, and not in separate proxies.

When an application needs to reference the paged objects, the suspect loitering objects are correctly re-loaded, possibly via proxy brokerage, and synchronized when the application needs them. When the object is paged to persistent storage, a custom serializer is invoked. A serializer is a method for converting object data to another form of data, such as binary or eXtensible Mark-up Language (XML). The serializer computes and stores a fingerprint for each stored object. A fingerprint is a numeric value computed for an object as a cryptographic checksum. The fingerprint is used to check an object's integrity. A stream-unique object identifier is also generated. A stream-unique object identifier is a numeric value that the object received at the relevant output stream during the serialization. In the case of an implementation in Java™ code, the Java™ hash code value of the stored object is also computed and stored. The data elements described above, for all of the objects managed by the healing unit, are all maintained within a data repository denoted as “healing data repository”. The healing data repository further holds the information needed for correct management of the healed objects, e.g., the proxy managing each object. After the “healing data repository” is populated, the reference to the object is set to null. The object is collected by the garbage collector at a later time.

In exemplary embodiments, a finalization mechanism is leveraged. For example, in one exemplary embodiment implemented utilizing the Java™ programming language, if an object has a finalize method, the JVM guarantees that the finalize method runs before the garbage collector frees the object's memory. A finalize method is typically used to release system resources. The call to the finalize method for a paged object is intercepted by the self-healing framework. When the finalize method is called for an object, there are no references to the object and the object is no longer considered as system memory resident. Thus, the relevant entries in the “healing data repository,” used for synchronization processes when deserializing objects from persistent storage, are removed. In exemplary embodiments, a method used for paging objects to persistent storage and populating the relevant entries in the “healing data repository” of the healing unit is called. For example, in an exemplary embodiment implemented utilizing the Java™ programming language, the method is referred to as an onObjectFinalize method. This method updates the paged version of the object in case there was a change in the object's state between the time the object was saved and the current time in which the object is about to be garbage collected.

The onObjectFinalize method updates the paged version of the suspected loitering object in case there was change in the suspect loitering object's state between the time the suspect loitering object was saved and the time of garbage collection. Then, a new fingerprint is calculated for the suspect loitering object. The new fingerprint is compared with the value saved on persistent storage for the suspected loitering object that was calculated by the serializer. If there is a difference between the fingerprints, then a change has occurred to the suspected loitering object and the on-persistent storage representation of the suspected loitering object is updated correspondingly.

For suspected loitering objects that have been paged and then are later accessed by the application, if the proxy or the healing unit references a suspected loitering object that is in system memory, the suspected loitering object is used directly. Otherwise, the healer uses the serializer to deserialize the suspected loitering object from the hard drive. A healing unit may comprise one or more healing units. In an alternate implementation, a healer is separate from a healing unit. The healer synchronizes between the memory objects and the deserialized objects to avoid any discrepancies. This is necessary because, in some healing cases, where objects are not flat, some data members of an object “A” may be in memory while others are on persistent storage. This happens when the former data members are referenced by objects external to “A”.

There may be cases in which one would like to apply memory leak resolution without having an explicit indication of a memory leak problem. For instance, an application may be developing a memory shortage problem even before a clear indication of memory shortage can be determined. Therefore, it might be useful to activate the memory leak resolution process even without an indication of a problem. In some cases, there may be applications for which it is known or suspected that memory leaks will occur sometime during the application's lifetime. In such cases, activating the memory resolution mechanism can serve as a preventive action.

Even with no knowledge regarding the possibility of memory leaks for a specific application, activating the memory resolution process regardless of a problem being detected may prove beneficial. Additionally, given the relatively low overhead of the memory resolution process, which may be controlled by configuring the parameters of the process such as, for example, the frequency of paging, periodically running exemplary embodiments allows for the resolution of unknown memory leaks at a relatively low overhead. This is somewhat similar like taking vitamins even though you have no illness.

Thus, exemplary embodiments provide for manually initiating the memory resolution process for a set of selected applications. A set of selected applications comprises one or more selected applications. Other exemplary embodiments provide for scheduling the memory resolution process to be initiated periodically for a set of selected applications. Further, in an exemplary embodiment, a set of selected applications may be chosen automatically, based on a set of rules. The exemplary embodiments increase availability of memory resources without having an indication of memory shortage, at a cost of a small reduction in the performance of the application.

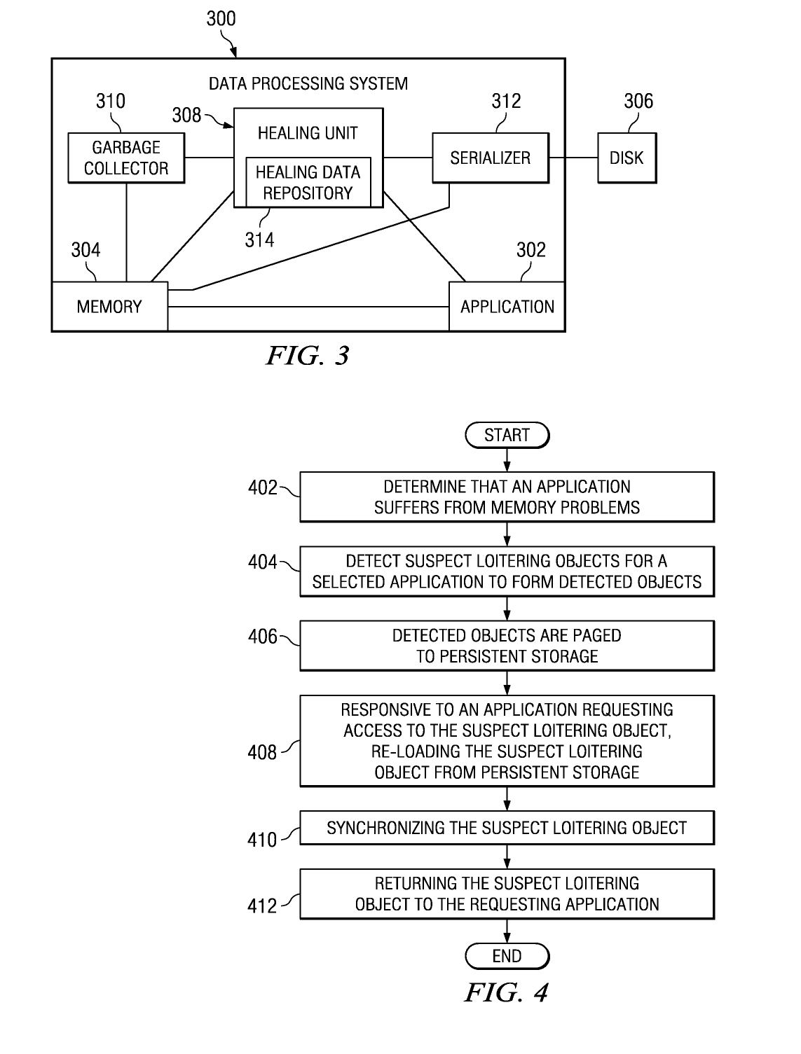

FIG. 3 is a block diagram illustrating a system in which exemplary embodiments may be implemented. Data processing system 300 is a data processing system and may be implemented as data processing system 200 in FIG. 2. Data processing system 300 comprises application 302; garbage collector 310; healing unit 308; serializer 312; system memory, memory 304; and persistent storage, disk 306. Memory 304 may be implemented as memory 206 in FIG. 2. Disk 306 may be implemented as persistent storage 208 of FIG. 2. Healing unit 308 comprises one or more healers (not shown) and healing data repository 314. Healing data repository 314 may be implemented as system memory or persistent storage, such as memory 206 and persistent storage 208 of FIG. 2.

While in the present example application 302 is a single application, it should be understood that other exemplary embodiments apply to a set of applications, wherein the set is comprised of one ore more selected applications. Further, it should be understood that the set of selected applications may be selected manually by a user or automatically, by the system or a monitor, such as healing unit 308, according to a set of rules.

Application 302 is an object oriented language application that references objects stored in memory 304. Healing unit 308 is a self-healing unit for data processing system 300. Self-healing means a system for monitoring for performance issues. The monitor, healing unit 308, analyzes data processing system 300 to detect anomalies, determine the root cause of the anomalies, and fix the problem. Fixing may take many forms, including, re-configuring a data processing system, altering existing code, and so forth.

When healing unit 308 determines that application 302 needs more memory, healing unit 308 detects suspect loitering objects, and invokes serializer 312 to page the detected objects to persistent storage, disk 306. Data structures corresponding to the paged suspect loitering object are populated in healing data repository 314. Garbage collector 310 deallocates the object when invoked.

In another exemplary embodiment, rather than healing unit 308 detecting suspect loitering objects for application 302 in response to healing unit 308 determining that application 302 needs more memory, healing unit 308 is implemented such that healing unit 308 periodically 308 detects for suspect loitering objects for application 302. Further, in another exemplary embodiment, healing unit 308 is implemented such that a user manually initiates healing unit 308 to detect suspect loitering objects for application 302.

FIG. 4 is flowchart illustrating the operation of managing memory in accordance with an exemplary embodiment. The operation of FIG. 4 may be performed by a garbage collector, such as garbage collector 310 and a healing unit, such as healing unit 308 in FIG. 3. The operation begins when a determination is made, by a healing unit for example, that an application suffers from memory problems (step 402). In another exemplary embodiment, step 402 is omitted and the operation begins when the operation detects suspect loitering objects for a selected application to form detected objects (step 404). The present exemplary embodiment is explained in reference to a single selected application. However, it should be understood that alternate exemplary embodiments encompass a set of selected applications. A set of selected applications comprises one or more selected applications. Further, the set of selected applications may be selected manually, by a user or automatically, according to a set of rules. The detected objects are paged to persistent storage (step 406). The detected objects are deallocated from memory (step 407). Responsive to an application requesting access to the suspect loitering object, re-loading the suspect loitering object from persistent storage (step 408), synchronizing the suspect loitering object (step 410), and returning the suspect loitering object to the requesting application (step 412) and the operation ends.

Further, in alternate embodiments, the operation of FIG. 4 may be performed on a periodic basis, according to a set of rules or the operation of FIG. 4 may be initiated manually by a user.

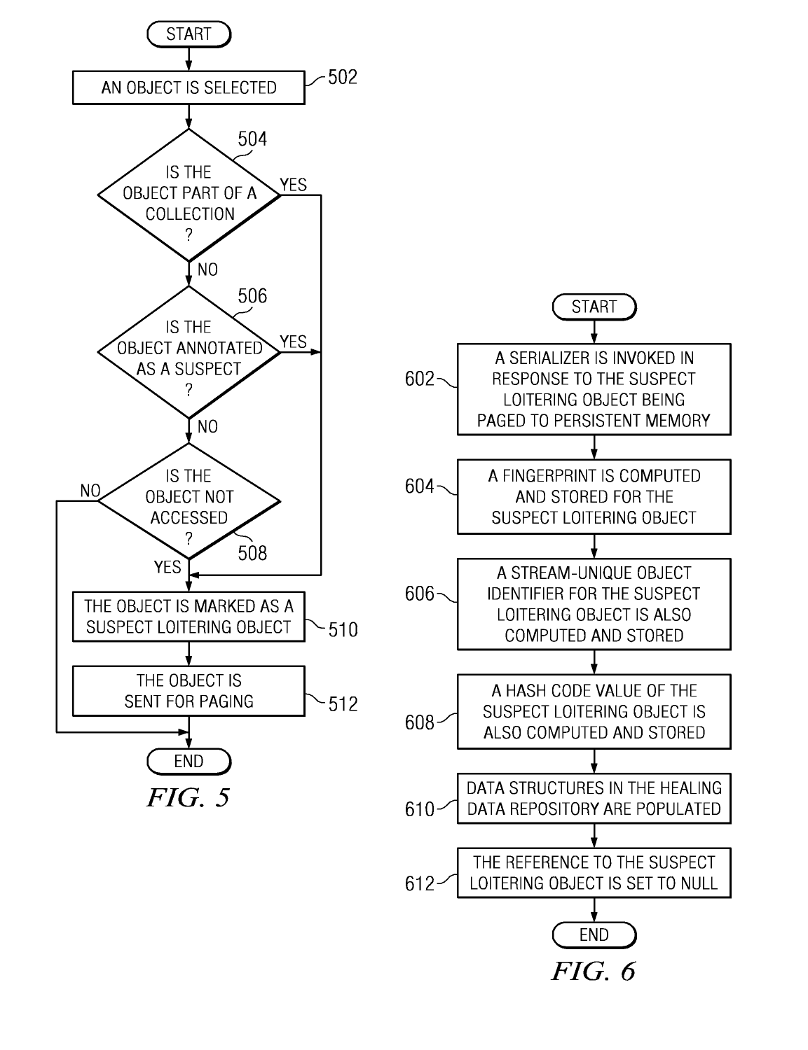

FIG. 5 is flowchart illustrating the operation of detecting suspect loitering objects in accordance with an exemplary embodiment. The operation of FIG. 5 may be performed by a healing unit, such as healing unit 308 in FIG. 3. An object is selected (step 502). A determination is made as to whether the object is part of a collection (step 504). If it is determined that the object is part of a collection (a “yes” output to step 504), then the object is marked as a suspect loitering object (step 510). The object is sent for paging (step 512) and the operation ends.

If it is determined that the object is not part of a collection (a “no” output to step 504), a determination is made as to whether the object is annotated as a suspect (step 506). Annotation of objects can be performed in at least one of the following two (2) ways. First is manual annotation. Manual annotation is where a developer adds annotations to a program code at the locations in the code that the programmer perceives as appropriate, using externally held information about the chances of objects to be suspected for loitering. Second is automated annotation. Automated annotation is where common code patterns are automatically detected; for example, collection handling with poor object addition and disposal and then annotations are added to the objects in which suspect patterns have been identified. If it is determined that the object is annotated as a suspect (a “yes” output to step 506), then the object is marked as a suspect loitering object (step 510). The object is sent for paging (step 512) and the operation ends. If it is determined that the object is not annotated as a suspect (a “no” output to step 506), a determination is made as to whether the object is not accessed (step 508). Typically, this determination is made by examining the last time the object was accessed.

If it is determined that the object is being accessed (a “no” output to step 508), then the object is not a loitering object and the operation ends. If it is determined that the object is not being accessed (a “yes” output to step 508), then the object is marked as a suspect loitering object (step 510), sent for paging (step 512) and the operation ends.

Exemplary embodiments detect suspect loitering objects by combining several criteria into a heuristic. In an exemplary embodiment, the heuristic comprises at least the following three criteria: (1) the objects are part of collections, (2) the objects are annotated as suspected loitering objects, and (3) the objects are not accessed. That is, the last access time the object is inspected. In various implementations, a user may wish to add other criteria specific to the user's problem or environment as part of the heuristic.

FIG. 6 is a flowchart illustrating the operation of paging a suspected loitering object to persistent storage in accordance with an illustrative embodiment. The operation of FIG. 6 may be performed by a healing unit, such as healing unit 308 in FIG. 3. The operation begins when a serializer is invoked in response to the suspect loitering object being paged to persistent storage (step 602). A fingerprint is computed and stored for the suspect loitering object (step 604). A stream-unique object identifier for the suspect loitering object is also computed and stored (step 606). A hash code value of the suspect loitering object is also computed and stored (step 608). Data structures in a data repository, such as, for example, the “healing data repository,” are populated (step 610). The reference to the suspect loitering object is set to null (step 612) and the operation ends.

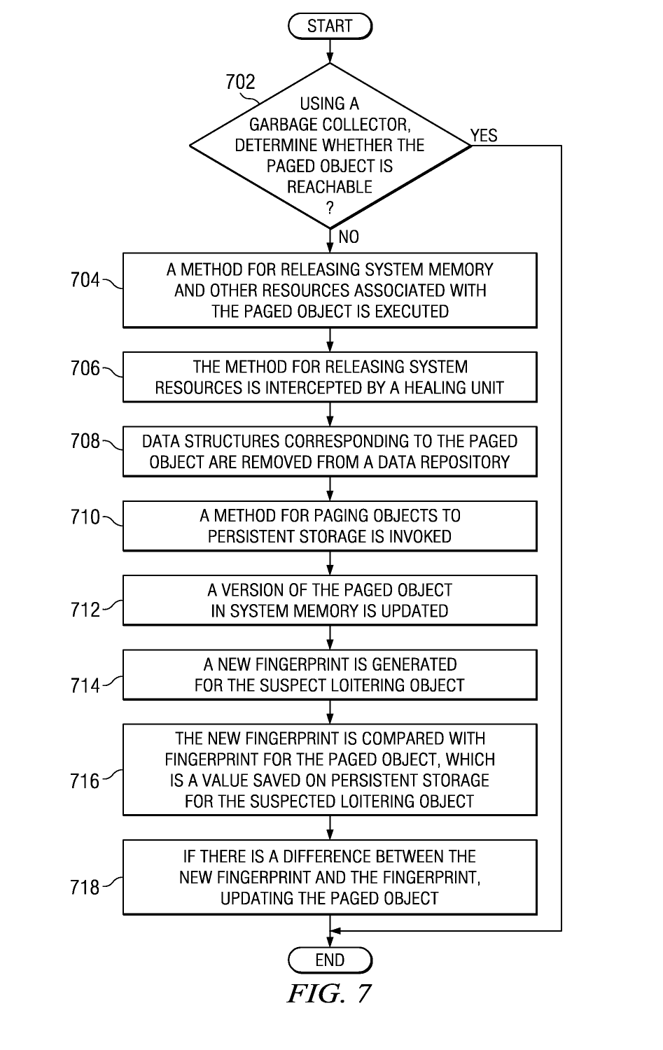

FIG. 7 is a flowchart illustrating the operation of garbage collecting in accordance with an exemplary embodiment. The operation of FIG. 7 may be performed by a garbage collector, such as garbage collector 310 and a healing unit, such as healing unit 308 in FIG. 3. The operation begins by determining, using a garbage collector, whether the paged object is reachable (step 702). If the operation determines that the paged object is reachable (a “yes” output to step 702), then the operation ends. Responsive to a determination that the paged object is not reachable (a “no” output to step 702), a method for releasing system memory and other resources associated with the paged object is executed (step 704). The method for releasing system resources is intercepted by a healing unit (step 706). Data structures corresponding to the paged object are removed from a data repository (step 708). For example, the relevant entries in the “healing data repository” are removed. A method for paging objects to persistent storage is invoked (step 710). For example, a method of a healer of the healing unit for paging objects to persistent storage is invoked.

A version of the paged object in system memory is updated (step 712). For example, a method of a healer for paging objects to persistent storage updates the paged version of the suspected loitering object. A new fingerprint is generated for the suspect loitering object (step 714). The new fingerprint is compared with fingerprint for the paged object, which is a value saved on persistent storage for the suspected loitering object (step 716). Responsive to a determination that there is a difference between the new fingerprint and the fingerprint, updating the paged object (step 718) and the operation ends. In other words, the on-persistent storage representation of the suspected loitering object is updated correspondingly and the operation ends.

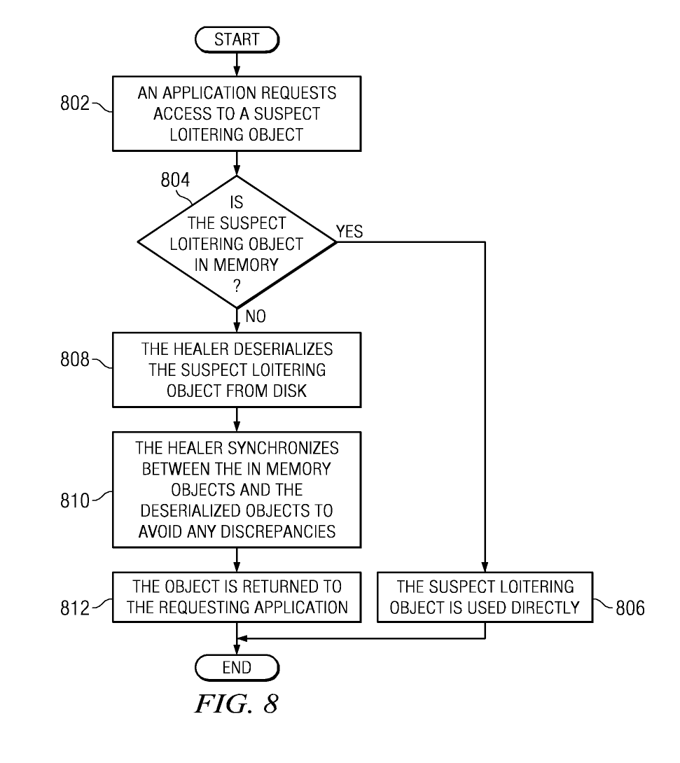

FIG. 8 is a flowchart illustrating the reloading of a suspect loitering object in accordance with an exemplary embodiment. The operation of FIG. 8 may be performed by a healing unit, such as healing unit 308 in FIG. 3. The operation begins when an application requests a suspect loitering object (step 802). A determination is made as to whether the suspect loitering object is in memory (step 804). If the operation determines that the suspect loitering object is in memory (a “yes” output to step 804), the suspect loitering object is used directly (step 806).

If the operation determines that the suspect loitering object is not in memory (a “no” output to step 804), the suspect loitering object is deserialized from persistent storage (step 808). For example, the healer uses a serializer to deserialize suspect loitering objects from persistent storage. The in memory objects and the deserialized objects are synchronized to avoid any discrepancies (step 810). For example, the healer synchronizes between the he in memory objects and the deserialized objects. The deserialized object is returned after the synchronization to the requesting application (step 812) and the operation ends.

Thus, exemplary embodiments provide for an automated, self-healing method for dealing with loitering objects. Specifically, exemplary embodiments include a mechanism, an algorithm, and supporting data structures for solving the loitering objects problem. The mechanism may be implemented as a standalone solution, or the mechanism may be integrated into other mechanisms. Exemplary embodiments may be implemented in any object oriented programming language. The main idea of the algorithm is to locate live objects that are suspected as being loitering objects and “page” the suspected live objects to persistent storage. Paging the suspected live objects to persistent storage avoids the need to explicitly find out whether the suspected live objects are indeed loitering objects. In case these suspected live objects are needed by the application later on, the suspected loitering objects are re-loaded from persistent storage to memory, with all related synchronization issues being handled carefully, to avoid inconsistencies.

Exemplary embodiments are designed to handle complex objects where each object may include a whole hierarchy of objects, and where objects may be referenced by multiple other objects. Exemplary embodiments provide an automated run-time method for addressing the problem of loitering objects. Unlike previous solutions, which address memory problems on a system wide basis, exemplary embodiments manage memory leak problems on an application-by-application basis. That is, exemplary embodiments perform memory management when an application needs memory as opposed to when the entire system needs memory.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing memory, the computer implemented method comprising:
detecting a suspect loitering object for a set of selected applications, forming a detected object;
paging the detected object to persistent storage, forming a paged object;
deallocating the paged object from system memory, forming a deallocated object.

2. The computer implemented method of claim 1, further comprising:
responsive to the application requesting the deallocated object, loading the paged object; and
responsive to loading the paged object, synchronizing the paged object with a version of the paged object in system memory.

3. The computer implemented method of claim 1, wherein detecting the suspect loitering object for the set of selected applications, forming the detected object, comprises:
selecting an object, forming a selected object;
using one of a systematic algorithm and a heuristic to analyze the selected object to determine whether the selected object is a suspect loitering object.

4. The computer implemented method of claim 3, wherein the heuristic is at least one of:
determining whether the selected object is part of a collection;
determining whether the selected object is annotated as a suspect object; and
determining whether the selected object is accessed.

5. The computer implemented method of claim 1, wherein paging the detected object to persistent storage, forming a paged object, comprises:
responsive to the detected object being paged to persistent storage, generating a fingerprint for the paged object;
storing the fingerprint;
generating a stream-unique object identifier for the paged object;
storing the stream-unique object identifier;
generating a hash code value for the paged object;
storing the hash code value;
populating data structures corresponding to the paged object; and
setting a reference to the paged object to null.

6. The computer implemented method of claim 5, wherein deallocating the paged object from system memory, forming a deallocated object, comprises:
determining, using a garbage collector, whether the paged object is reachable;
responsive to a determination that the paged object is not reachable, executing a method for releasing system memory and other resources associated with the paged object;
removing data structures corresponding to the paged object from a data repository;
invoking a method for paging objects to persistent storage;
updating a version of the paged object in system memory;
generating a new fingerprint for the paged object;
comparing the new fingerprint to the fingerprint; and
responsive to a determination that there is a difference between the new fingerprint and the fingerprint, updating the paged object.

7. The computer implemented method of claim 1, further comprising:
determining, by a monitoring unit, that an application needs more memory.

8. The computer implemented method of claim 1, wherein detecting a suspect loitering object for a set of selected applications, forming a detected object comprises
detecting the suspect loitering object for the set of selected applications, forming the detected object, in response to a determination that the set of selected applications needs more memory.

9. A computer program product comprising:
a computer recordable medium having computer usable program code for managing memory, the computer program product comprising:
computer usable program code for detecting a suspect loitering object for a set of selected applications, forming a detected object;
computer usable program code for paging the detected object to persistent storage, forming a paged object; and
computer usable program code for deallocating the paged object from system memory, forming a deallocated object.

10. The computer program product of claim 9, further comprising:
responsive to the application requesting the deallocated object, loading the paged object; and
responsive to loading the paged object, synchronizing the paged object with a version of the paged object in system memory.

11. The computer program product of claim 9, wherein the computer usable program code for detecting the suspect loitering object for the set of selected applications, forming the detected object, comprises:
computer usable program code for selecting an object, forming a selected object; and
computer usable program code for using one of a systematic algorithm and a heuristic to analyze the selected object to determine whether the selected object is a suspect loitering object.

12. The computer program product of claim 11, wherein the heuristic is at least one of:
determining whether the selected object is part of a collection;
determining whether the selected object is annotated as a suspect object; and
determining whether the selected object is accessed.

13. The computer program product of claim 9, wherein the computer usable program code for paging the detected object to persistent storage, forming a paged object, comprises:
computer usable program code, responsive to the detected object being paged to persistent storage, for generating a fingerprint for the paged object;
computer usable program code for storing the fingerprint;
computer usable program code for generating a stream-unique object identifier for the paged object;
computer usable program code for storing the stream-unique object identifier;
computer usable program code for generating a hash code value for the paged object;
computer usable program code for storing the hash code value;
computer usable program code for populating data structures corresponding to the paged object; and
computer usable program code for setting a reference to the paged object to null.

14. The computer program product of claim 13, wherein the computer usable program code for deallocating the paged object from system memory, forming a deallocated object, comprises:
computer usable program code for determining, using a garbage collector, whether the paged object is reachable;
computer usable program code for, responsive to a determination that the paged object is not reachable, executing a method for releasing system memory and other resources associated with the paged object;
computer usable program code for removing data structures corresponding to the paged object from a data repository;
computer usable program code for invoking a method for paging objects to persistent storage;
computer usable program code for updating a version of the paged object in system memory;
computer usable program code for generating a new fingerprint for the paged object;
computer usable program code for comparing the new fingerprint to the fingerprint; and
computer usable program code, responsive to a determination that there is a difference between the new fingerprint and the fingerprint, for updating the paged object.

15. A data processing system for managing memory, the data processing system comprising:
a bus;
a communications unit connected to the bus;
a storage device connected to the bus, wherein the storage device includes computer usable program code; and
a processor unit connected to the bus, wherein the processor unit executes the computer usable program code to detect suspect loitering object for a set of selected applications, forming a detected object; page the detected object to persistent storage, forming a paged object; and deallocate the paged object from system memory, forming a deallocated object.

16. The data processing system of claim 15, wherein the processor unit further executes the computer usable program code to, responsive to the application requesting the deallocated object, load the paged object; and, responsive to loading the paged object, synchronize the paged object with versions of the paged object in system memory.

17. The data processing system of claim 15, wherein the processor unit executing the computer usable program code to detect the suspect loitering object for the set of selected applications, forming the detected object, further comprises:
the processor unit executing computer usable program code to select an object, forming a selected object; use one of a systematic algorithm and a heuristic to analyze the selected object to determine whether the selected object is a suspect loitering object.

18. The data processing system of claim 17, wherein the heuristic is at least one of:
determining whether the selected object is part of a collection;
determining whether the selected object is annotated as a suspect object; and
determining whether the selected object is accessed.

19. The data processing system of claim 15, wherein the processor unit executing the computer usable program code to page the detected object to persistent storage, forming a paged object, further comprises:
the processor unit executing computer usable program code to, responsive to the detected object being paged to persistent storage, generate a fingerprint for the paged object; store the fingerprint; generate a stream-unique object identifier for the paged object; store the stream-unique object identifier; generate a hash code value for the paged object; store the hash code value; populate data structures corresponding to the paged object; and set a reference to the paged object to null.

20. The data processing system of claim 19, wherein the processor unit executing the computer usable program code to deallocate the paged object from system memory, forming a deallocated object, further comprises:
the processor unit executing computer usable program code to determine, using a garbage collector, whether the paged object is reachable, responsive to a determination that the paged object is not reachable, execute a method for releasing system memory and other resources associated with the paged object; remove data structures corresponding to the paged object from a data repository; invoke a method for paging objects to persistent storage; update a version of the paged object in system memory; generate a new fingerprint for the paged object; compare the new fingerprint to the fingerprint; and, responsive to a determination that there is a difference between the new fingerprint and the fingerprint, update the paged object.
